(19) United States
(12) Patent Application Publication
(10) Pub. No.: US 2003/0207625 A1
(43) Pub. Date: Nov. 6, 2003

(54) Wire straightener for glass-based bulbs

(76) Inventors: Ronald E. Thomas, Warren, PA (US); Roman J. Witek JR., Gibralter, MI (US)

Correspondence Address: OSRAM SYLVANIA Inc., 100 Endicott Street, Danvers, MA, 01923, US

(21) Appl. No.: 10/136,243

(22) Filed: May 1, 2002

(51) Int. Cl. H01R 11/22

(52) U.S. Cl. 439/857

(57) ABSTRACT

An electrical contact (10) for receiving an incandescent bulb (12) having a glass body (14) enclosing a filament (16), a necked-down portion (18) and a glass base (20) having two lead-ins (22, 24) projecting from an end (26) thereof, each of the lead-ins (22, 24) having a looped, electrically conducting wire that is formed at a 180° angle to lay against the glass base (20), one of the lead-ins laying on one side of the glass base and the other of the lead-ins laying on the other side of the base. The contact (10) has oppositely disposed, spaced apart arms (30, 32) formed to receive and hold the bulb. One of the arms also makes electrical contact with one of the lead-ins. A lead-in straightener (33) is formed on the arm formed to make electrical contact with the lead-in, whereby misaligned lead-ins are straightened when the bulb is inserted into a socket (40).

### TECHNICAL FIELD

This invention relates to electrical sockets and more particularly to such sockets for receiving glass-based bulbs. Still more particularly it relates to contacts for such a sockets, the contacts including lead-in straighteners.

### BACKGROUND ART

Glass-based or baseless bulbs have many uses, particularly in the automotive industry where such bulbs are employed for dashboard lighting, brake lights, taillights and parking lights and turn signal indicators. The bulbs comprise glass bodies with the lead-ins taking the form of bent wires that exit from the bottom of the base and are bent 180° to lay along the side of the base. These bulbs are inserted into sockets that have mating pairs of contacts that not only make the electrical connection but also hold the bulbs into the socket.

The fragile nature of the bulb lead-ins, extending as they do along the base of the bulb without any protection, often contributes to the lead-ins becoming misaligned during shipment, causing delays and added expense for the end user, who must manually straighten the lead-ins before inserting the bulb in the socket, or risk a “no light” situation or an intermittent condition.

### DISCLOSURE OF INVENTION

It is, therefore, an object of the invention to obviate the disadvantages of the prior art.

It is another object of the invention to enhance the operation of baseless bulbs.

It is yet another object of the invention to improve the electrical contacts for baseless light bulbs.

Still another object of the invention is the provision of an electrical contact for baseless light bulbs that will automatically straighten bent lead-ins.

These objects are accomplished, in one aspect of the invention, by an electrical contact comprising a lead-in straightener formed on the arm of the contact that functions to make electrical connection with the lead-in.

The feature of the built-in lead-in straightener eliminates the previous manual manipulation of bent lead-ins.

### BRIEF DESCRIPTION OF THE DRAWINGS

FIG. 1 is a diagrammatic, elevational view of a light bulb that cam be employed with the invention;

FIG. 2 is a partial perspective of a socket for receiving a light bulb;

FIG. 3 is an elevational view of an electrical contact in accordance with an aspect of the invention; and

FIG. 4 is an enlarged, perspective view of an arm of the contact, illustrating an aspect of the invention.

### BEST MODE FOR CARRYING OUT THE INVENTION

For a better understanding of the present invention, together with other and further objects, advantages and capabilities thereof, reference is made to the following disclosure and appended claims in conjunction with the above-described drawings.

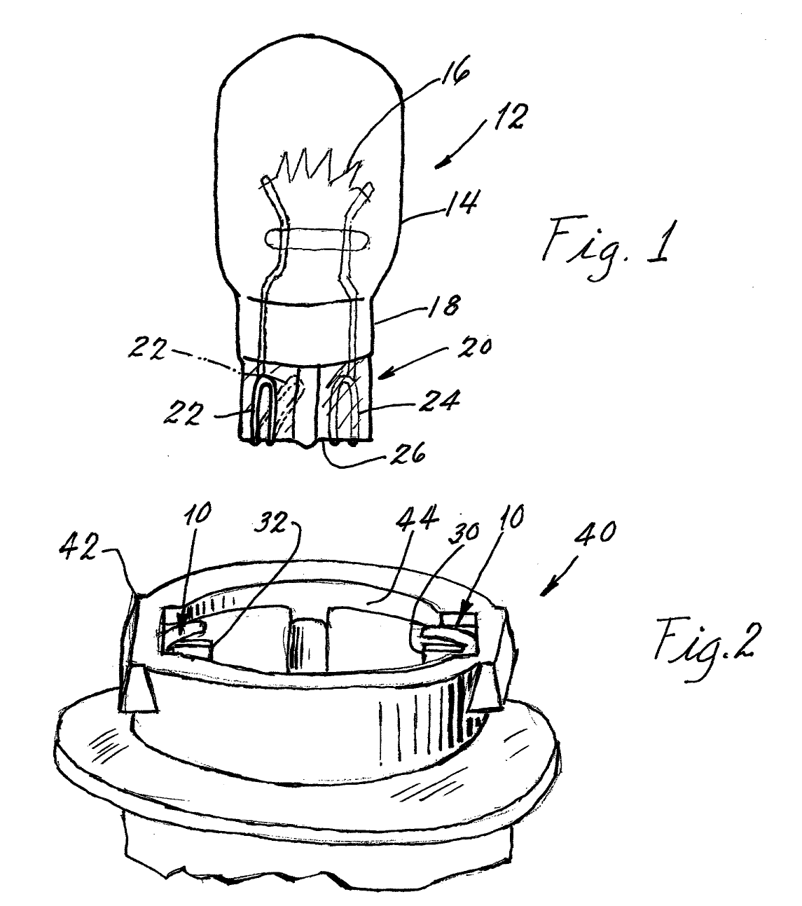

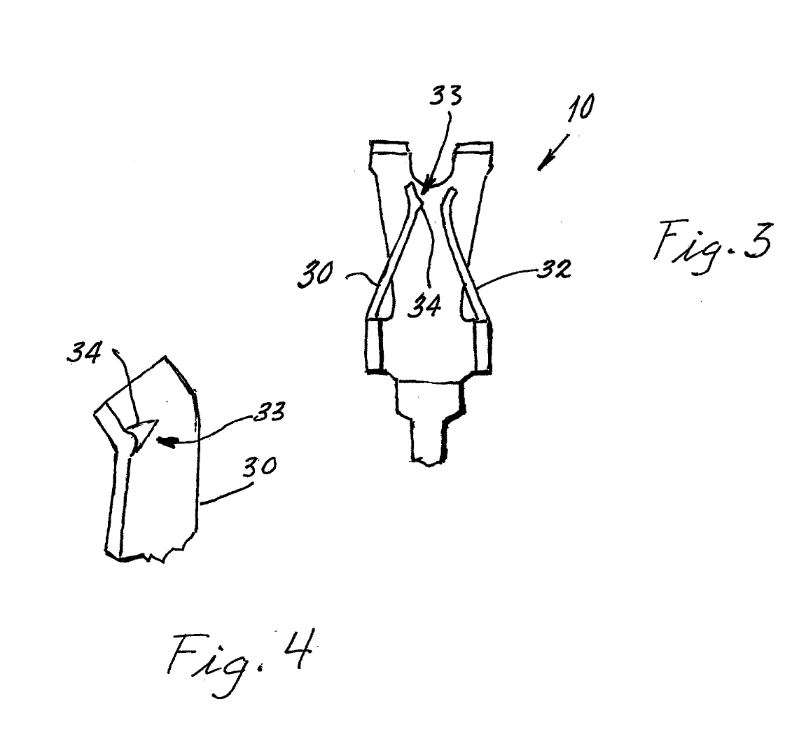

Referring now to the drawings with greater particularity, there is shown in FIG. 1 a light bulb 12 employable with this invention. The incandescent bulb 12 has a glass body 14 enclosing a filament 16, a necked-down portion 18 and a glass base 20 having two lead-ins 22, 24 projecting from an end 26 thereof. Each of the lead-ins 22, 24 comprises a looped, electrically conducting wire that is formed at a 180° angle to lay against the glass base 20. One of the lead-ins lays on one side of the glass base and the other of the lead-ins lays on the other side of the base. In FIG. 1, one of the lead-ins, 22, is shown also in phantom lines in a misaligned position, which can occur during shipping of the bulbs from the manufacturer to the end user.

The bulbs 12 are typically seated for use in a socket 40, shown in FIG. 2. The socket 40 has a body 42 with an aperture 44 therein. The aperture 42 receives a pair of contacts 10 for providing electrical and mechanical connection to a bulb 12. The pair of contacts is positioned in the aperture (44) of the socket (40) such that the lead-in straighteners (33) are diagonally opposite one another to accommodate the lead-ins being positioned on opposite sides of the bulb base.

In the present instance the contact 10 comprises oppositely disposed, spaced apart arms 30, 32 formed to receive and hold the bulb 12. One of the arms, for example, arm 30, also makes electrical contact with one of the lead-ins. The arm 30 includes a lead-in straightener 33 formed thereon.

In a preferred embodiment, the lead-in straightener 33 comprises a protrusion 34 that extends less than half the width of the arm 30, and has a height of about 0.14 inches that diminishes to nothing at the end of its length. For a bulb designed for automotive use, i.e., a T5 envelope having a diameter of ⅝ of an inch, the typical contact arm 30 would have a width of ⅛ and a thickness of 0.45 inches.

The lead-in straightener 33 provides a camming action when the bulb 12 is inserted into the socket, straightening lead-in and insuring adequate contact.

While the description above refers specifically to baseless light bulbs, the lead-in straightening concept is applicable to other components having fragile lead-ins subject to misalignment during shipping.

While there have been shown and described what are at present considered to be the preferred embodiments of the invention, it will be apparent to those skilled in the art that various changes and modification can be made herein without departing from the scope of the invention as defined by the appended claims.

What is claimed is:

1. In an electrical contact for receiving an incandescent bulb having a glass body enclosing a filament, a necked-down portion and a glass base having two lead-ins projecting from an end thereof, each of said lead-ins comprising a looped electrically conducting wire that is formed at a 180° angle to lay against said glass base, one of said lead-ins laying on one side of said glass base and the other of said lead-ins laying on the other side of said base, said contact comprising oppositely disposed, spaced apart arms formed to receive and hold said bulb, one of said arms also making electrical contact with one of said lead-ins, the improvement comprising a lead-in straightener formed on said arm formed to make electrical contact with said lead-in.

2. The electrical contact of claim 1 wherein said lead-in straightener comprises a protrusion.

3. The electrical contact of claim 2 wherein said protrusion extends less than half of the width of said arm.

4. A socket for receiving a glass-based bulb having external lead-ins laying on opposite sides of the base of said bulb, said socket comprising: a body having an aperture therein and a pair of contacts disposed within said aperture, each of said pair of contacts comprising oppositely disposed, spaced apart arms formed to receive and hold said bulb, one of said arms of each of said pair of contacts also making electrical contact with one of said lead-ins and having a lead-in straightener formed thereon, said pair of contacts being positioned in said aperture of said socket such that said lead-in straighteners are diagonally opposite one another.

5. An electrical contact having opposed arms, one of which arms provides electrical contact with a lead-in from a plug-in device, said electrical contact comprising a lead-in straightener formed on said arm of said contact that functions to make electrical contact with the lead-in.
